(19) United States
(12) Patent Application Publication
(10) Pub. No.: US 2009/0143044 A1
(43) Pub. Date: Jun. 4, 2009

(54) METHOD AND APPARATUS FOR OPERATING A WIRELESS COMMUNICATION DEVICE IN AN ELECTROMAGNETICALLY SENSITIVE ENVIRONMENT

(75) Inventors: DEAN E. THORSON, GRAYSLAKE, IL (US); WILLIAM P. ALBERTH, JR., PRAIRIE GROVE, IL (US); DANIEL J. DECLERCK, LAKE BARRINGTON, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/948,567

(22) Filed: Nov. 30, 2007

(51) Int. Cl. H04Q 7/32; H04B 1/04; H04M 11/04

(52) U.S. Cl. 455/404.1; 455/127.4; 455/522

(57) ABSTRACT

A method and apparatus for operating a wireless communication device in an electromagnetically sensitive environment is disclosed. The method comprises selecting an operating mode of the wireless communication device. If the selected operating mode is a factory safe mode (225), the wireless communication device limits its maximum transmission power to a second value (242). The second value of the maximum transmission power is a value at which the electromagnetically sensitive devices in the electromagnetically sensitive environment are not affected.

### FIELD OF THE INVENTION

The present invention relates generally to a wireless communication system and more particularly to a method and apparatus for operating a wireless communication device in an electromagnetically sensitive environment.

### BACKGROUND

In a wireless communication system, a wireless communication device and a base station communicate with each other through radio frequency signals. The radio frequency signals have an electromagnetic field associated with them. This electromagnetic field can interfere with electromagnetically sensitive devices present in the surrounding area. Therefore, the operation of a wireless communication device in an environment having electromagnetically sensitive devices can lead to undesirable abnormalities in the electromagnetically sensitive devices.

For example, if a wireless communication device is used near an IC fabrication facility, the electromagnetic field produced by the wireless communication device can cause defects in the fabricated ICs. In another example, in an ordnance factory, the electromagnetic field of the radio frequency signals can cause accidental detonation of ordnance. The US Department of Defense has defined HERO (Hazards of Electromagnetic Radiation to Ordnance) certification for ordnance. According to the HERO certification, ordnance is categorized into HERO SAFE ordnance, HERO UNSAFE ordnance, and HERO SUSCEPTIBLE ordnance, according to the limit of the average power density of the electromagnetic field that can be sustained by the ordnance. For example, ordnance certified as HERO UNSAFE can sustain an electromagnetic field having an average power density of 20 nW/cm² at 1 GHz.

If a wireless communication device is operated in a sensitive environment at an unsafe power level, it can lead to an undesirable effect on the electromagnetically sensitive devices present in the sensitive environment. Generally, wireless communication devices are simply banned from electromagnetically sensitive environments, but users find that extremely inconvenient. Therefore, there is an opportunity to develop a wireless communication device that can operate in an electromagnetically sensitive environment without causing abnormalities in the electromagnetically sensitive devices.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system diagram of a wireless communication system having a picocell in accordance with some embodiments.

FIG. 2 is a flowchart of a method for a wireless communication device to limit its maximum transmission power in accordance with some embodiments.

FIG. 3 is a flowchart of a method for a base station to limit a maximum transmission power of the wireless communication device in accordance with some embodiments.

FIG. 4 is a block diagram of a wireless communication device in communication with a base station in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention provides a method and apparatus for operating a wireless communication device in an electromagnetically sensitive environment without causing abnormalities in the electromagnetically sensitive devices present in the electromagnetically sensitive environment. The wireless communication device selects an operating mode. If the selected operating mode is a “standard” mode, the wireless communication device limits its maximum transmission power to a first value. If the selected operating mode is a “factory safe” mode, the wireless communication device limits its maximum transmission power to a second value. The second value of the maximum transmission power is a value at which nearby electromagnetically sensitive devices are safe.

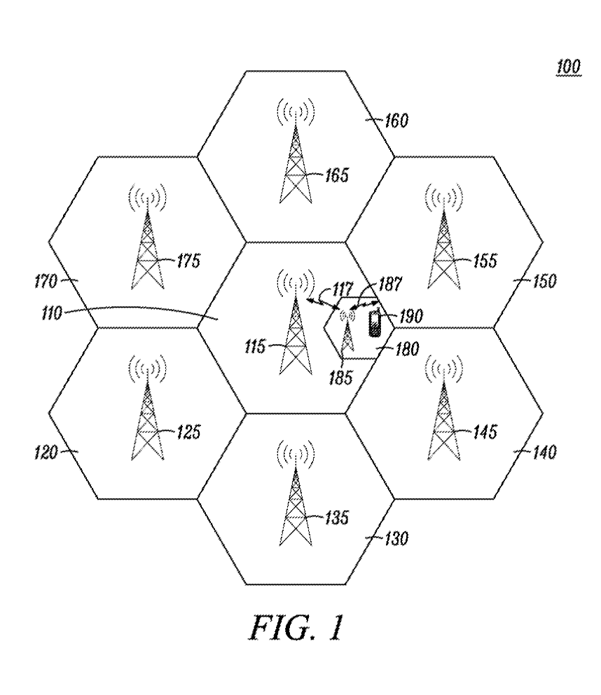

FIG. 1 is a system diagram of a wireless communication system 100 having a picocell 180 in accordance with some embodiments. The coverage area of the wireless communication system 100 is divided into a plurality of standard cells 110, 120, 130, 140, 150, 160, 170. Each standard cell is served by a standard base station. In the example of FIG. 1, different standard cells 110, 120, 130, 140, 150, 160, 170 are served by their respective standard base stations 115, 125, 135, 145, 155, 165, 175. Each standard base station connects the wireless communication devices present in the corresponding standard cell with a wireless communication network.

In the example of FIG. 1, the standard cell 110 includes a picocell 180. A picocell (e.g. 180) is similar to a standard cell (e.g. 110), but it covers a very small area compared to a standard cell. The picocell 180 includes an electromagnetically sensitive environment with electromagnetically sensitive devices in it. In one example, the electromagnetically sensitive environment is an IC fabrication facility. Alternatively, the electromagnetically sensitive environment may be an ordnance factory or storage facility.

The picocell 180 is served by a pico base station 185. The pico base station 185 connects the wireless communication devices present in the electromagnetically sensitive environment covered by the picocell 180, to the wireless communication network through the standard base station 115 of the standard cell 110 (of which the picocell 180 is a part). The pico base station 185 and the standard base station 115 communicate with each other using a radio frequency link 1 17. The pico base station 185 and the wireless communication devices in the picocell 180 (for example, wireless communication device 190) communicate with each other using a radio frequency link 187.

The pico base station 185 works similar to a standard base station, but at a lower maximum transmission power. Moreover, a pico base station may have a mechanism to inform the wireless communication devices in its picocell to limit their maximum transmission power. Because of the limited maximum transmission power of the pico base station and the wireless communication devices in the picocell, the electromagnetically sensitive devices present in the electromagnetically sensitive environment of the picocell are not affected. The mechanism may include communication devices recognizing an identification broadcast by the pico base station, or through other messages sent by the pico base station that cause the wireless communication device to operate in the factory safe mode.

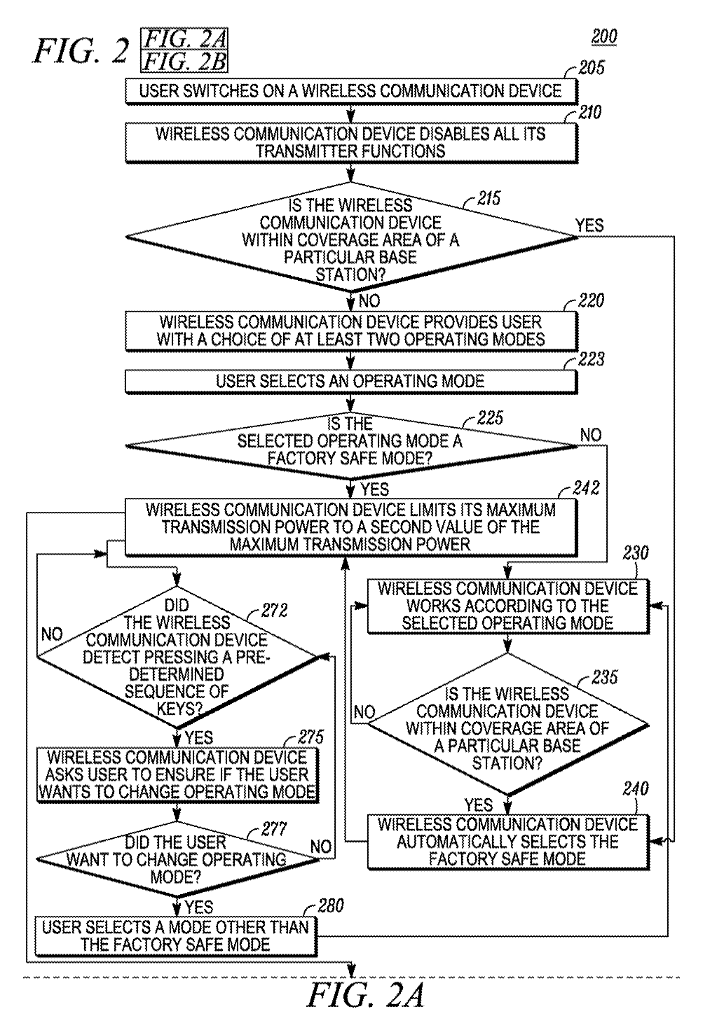

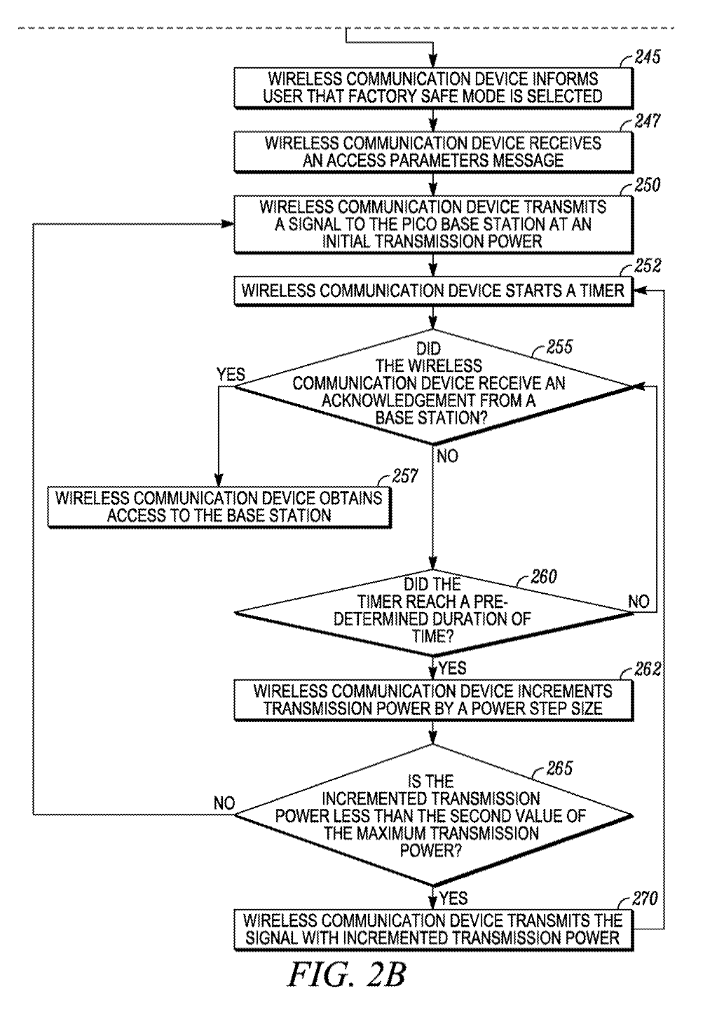

FIG. 2 is a flowchart of a method 200 for a wireless communication device to limit its maximum transmission power in accordance with some embodiments. The method starts in step 205, when a wireless communication device is switched ON by a user. As an example, the wireless communication device may be the wireless communication device 190 of FIG. 1. After switching ON, the wireless communication device 190 disables all its transmitter functions in step 210. After disabling, the wireless communication device 190 determines in step 215 whether it is within a coverage area of a particular base station which is known to cover an electromagnetically sensitive environment. In the example of FIG. 2, the particular base station is the pico base station 185 of FIG. 1.

In one example, the wireless communication device 190 determines that it is within the coverage area of the pico base station 185 if the wireless communication device 190 receives a notification message from the pico base station 185. The notification message may be an identifier broadcast by the pico base station 185. In this case, if the received identifier is known to the wireless communication device 190, it determines that it is within the coverage area of the pico base station 185. In another example, the wireless communication device 190 may determine its current location using a GPS receiver. In this case, the wireless communication device 190 compares the determined current location with a pre-determined list of location ranges stored in the memory of the wireless communication device 190. If the determined current location is within any location range from the pre-determined list of location ranges, the wireless communication device 190 determines that it is within the coverage area of the pico base station 185.

In step 215, if the wireless communication device 190 determines that it is within the coverage area of the particular base station, the wireless communication device 190 automatically selects a “factory safe” mode in step 240. When the “factory safe” mode is selected, the wireless communication device 190 limits its maximum transmission power to a second value as shown in step 242. The second value of the maximum transmission power is a predetermined value at which nearby electromagnetic devices will be safe. The second value is generally less than one percent of a first “standard” value of maximum transmission power.

Otherwise, if the wireless communication device 190 determines that it is not within the coverage area of the particular base station, in step 215, the wireless communication device 190 provides the user with a choice of operating modes in step 220. The first operating mode is a “standard” operating mode and the second operating mode is the “factory safe” mode. In the first operating mode, the maximum transmission power of the wireless communication device 190 is a first value. The first value of the maximum transmission power is the standard maximum transmission power used when the wireless communication device 190 communicates with the standard base stations 115, 125, 135, etc. In the second operating mode, the maximum transmission power of the wireless communication device 190 is a second value. The second value of the maximum transmission power is the maximum transmission power with which the wireless communication device 190 can communicate with the pico base station 185 without affecting electromagnetically sensitive devices present in the electromagnetically sensitive environment of the picocell 180. When presented with a choice of operating modes, the user then selects in step 223 an operating mode from the at least two operating modes available.

When the user selects an operating mode in step 223, the wireless communication device 190 determines whether the selected operating mode is the “factory safe” mode in step 225. If the selected operating mode is the “factory safe” mode, the wireless communication device 190 goes to step 242 and limits its maximum transmission power to a second value as previously described.

Otherwise, if the operating mode selected by the user in step 223 is not the “factory safe” mode as determined by the wireless communication device 190 in step 225, the wireless communication device 190 starts working according to the selected operating mode in step 230 and uses the first value of maximum transmission power. While working according to the selected operating mode, the wireless communication device 190 keeps re-determining whether it is within the coverage area of a particular base station in step 235 using the same techniques as explained earlier with reference to step 215.

If the wireless communication device 190 determines that it is not within the coverage area of a particular base station in step 235, the wireless communication device 190 continues to work according to the selected operating mode in step 230. Otherwise, if the wireless communication device 190 determines that it is within the coverage area of a particular base station in step 235, the wireless communication device 190 automatically selects the “factory safe” mode in step 240 and limits its maximum transmission power to the second value of the maximum transmission power in step 242.

After limiting the maximum transmission power to the second value in step 242, the wireless communication device 190, informs in step 245 its user that “factory safe” mode has been selected. For example, the display unit, a light emitting diode, or the speaker of the wireless communication device 190 may be used to inform the user of the wireless communication device about the selected operating mode either once, continually, or intermittently.

Meanwhile, the wireless communication device 190 works according to the “factory safe” mode. In the example of FIG. 2, the wireless communication device 190 receives an access parameters message in step 247, where the access parameters message is transmitted by a particular base station such as the pico base station 185. The access parameters message includes a value of initial transmission power and a value of power step size. The initial transmission power is the value of transmission power at which the wireless communication device 190 starts transmitting a signal to the particular base station and the power step size is the value by which the wireless communication device 190 increments the transmission power to the particular base station as needed to communicate effectively.

After receiving the access parameters message, the wireless communication device 190 transmits a signal to the particular base station at the initial transmission power in step 250 and starts a timer in step 252. After starting the timer, the wireless communication device 190 checks if it receives an acknowledgement from the particular base station in step 255 until the timer reaches a pre-determined duration of time. If the wireless communication device 190 receives an acknowledgement from the particular base station in step 255, it obtains access to the particular base station in step 257.

Otherwise, the wireless communication device 190 determines whether the timer has reached a pre-determined duration of time in step 260. If the wireless communication device 190 determines that the timer has not reached the pre-determined duration of time, it goes back to step 255 and keeps checking for the acknowledgement. If the wireless communication device 190 determines that the timer has reached the pre-determined duration of time without receiving an acknowledgement, the wireless communication device 190 increments the transmission power by the power step size in step 262.

After incrementing the transmission power, the wireless communication device 190 compares in step 265 the incremented transmission power with the second value of the maximum transmission power. If the incremented transmission power is less than the second value of the maximum transmission power, the wireless communication device 190 again transmits the signal (with the incremented transmission power) in step 270 and returns to step 252. Otherwise, the wireless communication device 190 again transmits the signal to the particular base station at the initial transmission power, according to step 250. The wireless communication device follows the same process again and again until an acknowledgement is received from the particular base station or another process instructs the wireless communication device to quit its attempt to obtain access to the particular base station.

While the wireless communication device 190 is operating in the “factory safe” mode, the user can select another operating mode by pressing a pre-determined sequence of keys. The pre-determined sequence of keys is designed to avoid accidental switching out of “factory safe” mode. If the wireless communication device 190 detects pressing any sequence of keys, it determines in step 272 whether the pressed sequence of keys is a pre-determined sequence of keys. If the wireless communication device 190 detects pressing a pre-determined sequence of keys in step 272, it asks the user to ensure that the user wants to change the operating mode in step 275. If the user acknowledges wanting to change the operating mode in step 277, then the user is permitted to select an operating mode other than the “factory safe” mode in step 280 and the wireless communication device 190 works according to the selected operating mode in step 230.

If the wireless communication device 190 does not detect pressing a pre-determined sequence of keys in step 272 or if the user does not acknowledge wanting to change the operating mode in step 277, the wireless communication device 190 returns to step 272 and keeps monitoring if a pre-determined sequence of keys is pressed by the user. Meanwhile, the wireless communication device 190 keeps working according to its current “factory safe” operating mode.

In the above example, “factory safe” mode may or may not apply to emergency calls. In one example, the user may enable or disable application of “factory safe” mode to emergency calls. In another example, an operator of the electromagnetically sensitive environment may enable or disable applying “factory safe” mode for emergency calls.

If “factory safe” mode for emergency calls is enabled, the wireless communication device does not increase the transmission power above the second value of maximum transmission power even if the emergency call is not possible at the second value of the maximum transmission power. In this case, the wireless communication device delays the emergency call for a certain period of time and then tries again at its second value of maximum transmission power.

Alternatively, if “factory safe” mode for the emergency calls is disabled, the wireless communication device increases the transmission power above the second value, if the emergency call is not possible at the second value of the maximum transmission power. In this case, the wireless communication device may send a message to the base station that indicates that a call will be made exceeding the second value of the maximum transmission power. In response, the base station may shut down processing that affects the electromagnetically sensitive environment and force the wireless communication device to delay the emergency call until damage to nearby electromagnetically sensitive devices can be mitigated.

In the above example of FIG. 2, the wireless communication device 190 disables in step 210 all of its transmitter functions when it is switched ON. As a result, if a wireless communication device 190 is switched ON in an electromagnetically sensitive environment (e.g. picocell 180), the electromagnetically sensitive devices present in the electromagnetically sensitive environment are not affected by a potentially high transmission power of the wireless communication device 190. After switching ON, the wireless communication device may determine that it is within an electromagnetically sensitive environment (e.g. picocell 180, or through location determined by GPS or other means). In this case, the wireless communication device selects the “factory safe” mode and limits its maximum transmission power to the second value of the maximum transmission power, which is generally less than one percent of the first value of the maximum transmission power. Thus, the electromagnetic field produced by the radio frequency signals transmitted by the wireless communication device 190 is not strong enough to affect the electromagnetic devices present in the electromagnetically sensitive environment.

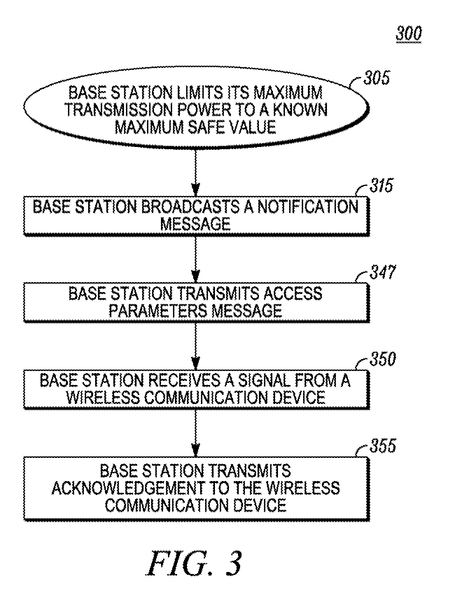

FIG. 3 is a flowchart 300 of a method for a base station to limit a maximum transmission power of the wireless communication device in accordance with some embodiments. As an example, the base station may be the pico base station 185 of FIG. 1. The pico base station 185 has a maximum transmission power that is limited to a known maximum safe value in step 305. The known maximum safe value is may be less than one percent of the maximum transmission power of a standard cell base station. The location of the pico base station will be known and fixed so that electromagnetic power transmitted does not exceed the levels that would perturb sensitive electromagnetic items in the area.

In order to inform the wireless communication devices that they are within the picocell 180, the pico base station 185 broadcasts a notification message in step 315. The wireless communication devices within the coverage area of the pico base station 185 may receive the notification message. The notification message has an identifier that is known to the wireless communication devices. The identifier indicates to the wireless communication devices that they are in the coverage area of the pico base station 185. In one example, the identifier in the notification message can be a base station identifier (BSID). The identifier may also indicate the electromagnetically sensitive environment in which the pico base station 185 is present. For example, a pico base station present within an IC fabrication facility transmits an identifier that informs the wireless communication devices receiving the identifier that they are within an IC fabrication facility. Another pico base station present within an ordnance transmits an identifier that informs the wireless communication devices receiving the identifier that they are within an ordnance facility. In this case, the wireless communication devices have to be pre-programmed to know the electromagnetically sensitive environment from the received identifier. In addition, the identifier may also indicate the second value of maximum transmission power for the wireless communication devices. As an example, the wireless communication device may be the wireless communication device 190 of FIG. 1.

After broadcasting the notification message, the pico base station 185 transmits an access parameters message in step 347. The access parameters message includes a value of initial transmission power and a value of power step size for the wireless communication devices within the picocell 180. The initial transmission power is the value of transmission power at which the wireless communication device 190 starts transmitting a signal to the pico base station 185, and the power step size is the value by which the wireless communication device 190 increments the transmission power each time a transmission is unsuccessful.

When a communication session is being established, the pico base station 185 receives a signal from the wireless communication device 190 in step 350. In response to the received signal, the pico base station 185 transmits an acknowledgement to the wireless communication device 190 in step 355.

In the above example, the pico base station 185 limits the maximum transmission power of a wireless communication device 190 present in the picocell 180. Thus, the electromagnetic field of the radio frequency signals transmitted by the pico base station 185 and the wireless communication device 190 is very weak and does not interfere with the working of electromagnetically sensitive devices present in the picocell 180.

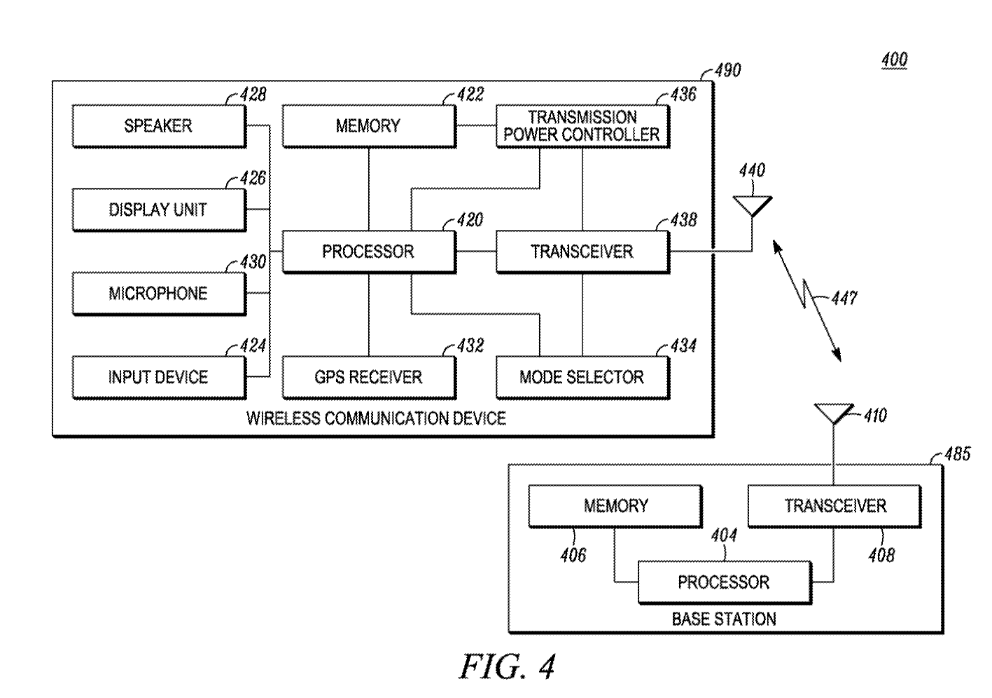

FIG. 4 is a block diagram 400 of a wireless communication device 490 in communication with a base station 485 in accordance with some embodiments. The wireless communication device 490 and the base station 485 are in communication with each other through a radio link 447. As an example, the wireless communication device 490 is the wireless communication device 190 present in the picocell 180 of FIG. 1 and the base station 485 is the pico base station 185 of FIG. 1.

The base station 485 includes a processor 404, a memory 406, a transceiver 408, and an antenna 410. The base station 485 works according to the method of FIG. 3. The antenna 410 receives and transmits signals. The antenna 410 is connected to the transceiver 408.

The processor 404 is coupled to the transceiver 408. The processor 404 limits the maximum transmission power of the transceiver 408 to a known maximum safe value. The known maximum safe value of the maximum transmission power is stored in the memory 406 coupled to the processor 404. The known maximum safe value of the maximum transmission power is the value of transmission power at which nearby electromagnetically sensitive devices are safe. In one example, the known maximum safe power for a pico base station is less than one percent of the maximum transmission power for a standard base station. The memory 406 also stores an initial transmission power and a power step size that are transmitted to the wireless communication device 490 in an access parameters message. The memory 406 may also store a second value of the maximum transmission power that may be transmitted to the wireless communication device 490 in the access parameters message using the transceiver 408.

The wireless communication device 490 includes a processor 420, a mode selector 434, a transmission power controller 436, a memory 422, an input device 424, a microphone 430, a display unit 426, a speaker 428, a GPS receiver 432, a transceiver 438, and an antenna 440. The wireless communication device 490 works according to the method of FIG. 2. The antenna 440 receives and transmits signals. The antenna 440 is connected to the transceiver 438.

The mode selector 434 selects an operating mode of the wireless communication device 490. It is coupled to the processor 420 which in turn is coupled to the input device 424, the microphone 430, the transceiver 438, the GPS receiver 432, and the transmission power controller 436. In one example, the mode selector 434 may select an operating mode based upon a pre-determined sequence of keys being pressed on the input device 424 by the user of the wireless communication device 490. In another example, the mode selector 434 may select an operating mode based upon a voice command entered by the user at the microphone 430. In yet another example, the operating mode may be selected by the mode selector 434 automatically, when it determines that a known identifier is received by the transceiver 438 in a notification message broadcasted by the base station 485. In this case, the operating mode selected by the mode selector 434 is “factory safe” mode. In another example, the operating mode may be selected by the mode selector 434 automatically, when it determines that the current GPS location received by the GPS receiver 432 is within a pre-determined location range stored in the memory 422 of the wireless communication device 490.

After the mode selector 434 selects an operating mode, the display unit 426 or the speaker 428 or an LED (not shown) informs the user of the selected operating mode. The display unit 426 and the speaker 428 are also coupled to the processor 420.

The transmission power controller 436 is coupled to the memory 422, the transceiver 438, and the processor 420, which in turn is coupled to the mode selector 434. The transmission power controller 436 selects a first or second value of the maximum transmission power of the wireless communication device 490 according to the operating mode selected by the mode selector 434. In one example, if the selected operating mode is the “factory safe” mode, then the transmission power controller 436 selects the second value of the maximum transmission power. Otherwise, the transmission power controller 436 selects the first value of the maximum transmission power.

By selecting the second value of the maximum transmission power as the maximum transmission power of the wireless communication device, when the wireless communication device is in “factory safe” mode, the electromagnetic field produced by the radio frequency signals transmitted by the wireless communication device is kept within a limit that does not affect the electromagnetic devices present in an electromagnetically sensitive environment.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for a wireless communication device comprising:
selecting an operating mode of the wireless communication device;
limiting, by the wireless communication device, a maximum transmission power of the wireless communication device to a second value of the maximum transmission power, if the selected operating mode is a “factory safe” mode, wherein the second value of the maximum transmission power is less than one percent of a first value of the maximum transmission power; and
setting, by the wireless communication device, the maximum transmission power of the wireless communication device to the first value of the maximum transmission power, if the selected operating mode is not the “factory safe” mode.

2. The method of claim 1, further comprising:
switching on the wireless communication device;
disabling all transmitter functions of the wireless communication device; and
providing a choice of at least two operating modes to a user of the wireless communication device, before the selecting.

3. The method of claim 2, further comprising:
indicating the selected operating mode to the user of the wireless communication device.

4. The method of claim 1, further comprising:
receiving, by the wireless communication device, a notification message broadcasted by a base station, wherein the notification message informs the wireless communication device that the wireless communication device is in a sensitive environment.

5. The method of claim 4, wherein the notification message is an identifier broadcasted by the base station and is known to the wireless communication device.

6. The method of claim 1, wherein selecting the operating mode of the wireless communication device is automatically performed by the wireless communication device, wherein the selected operating mode is the “factory safe” mode.

7. The method of claim 6, further comprising:
informing, by the wireless communication device, a user of the wireless communication device that the wireless communication device is in the “factory safe” mode.

8. The method of claim 1, further comprising:
receiving, from a user of the wireless communication device, a pre-determined sequence of key presses to change from the “factory safe” mode to a not “factory safe” mode, wherein the pre-determined sequence of key presses comprises at least two key presses; and
switching, by the wireless communication device, from the “factory safe” mode to the not “factory safe” mode.

9. The method of claim 1, further comprising:
determining, by the wireless communication device, a current location of the wireless communication device;
comparing, by the wireless communication device, the current location with a pre-determined list of at least one location range; and
switching, by the wireless communication device, the operating mode of the wireless communication device to the “factory safe” mode, if the current location is within the at least one location range from the pre-determined list, wherein the at least one location range from the pre-determined list is a location range of a sensitive environment.

10. The method of claim 9, wherein selecting further comprises:
informing, by the wireless communication device, a user of the wireless communication device that the wireless communication device is in the “factory safe” mode.

11. The method of claim 1, wherein limiting further comprises:
transmitting, by the wireless communication device, a signal to a pico base station at a transmission power equal to an initial transmission power;
incrementing, by the wireless communication device, the transmission power by a power step size, if no acknowledgement is received from the pico base station within a pre-determined duration of time;
comparing, by the wireless communication device, the incremented transmission power to the second value of the maximum transmission power;
re-transmitting, by the wireless communication device, the signal to the pico base station at the incremented transmission power, if the incremented transmission power is less than the second value of the maximum transmission power; and
re-transmitting, by the wireless communication device, the signal to the pico base station at the initial transmission power, if the incremented transmission power is greater than the second value of the maximum transmission power.

12. The method of claim 11, further comprising:
receiving, by the wireless communication device, an access parameters message, wherein the access parameters message contains the initial transmission power and the power step size, before transmitting.

13. The method of claim 1, further comprising:
allowing the wireless communication device, when it is making an emergency call, to disable “factory safe” mode, if the emergency call is not successful at the second value of the maximum transmission power.

14. The method of claim 13, wherein the wireless communication device sends a message informing a base station that a call will be made exceeding the second value of the maximum transmission power, before allowing.

15. The method of claim 14, wherein the wireless communication device delays the emergency call for a time period, before allowing.

16. The method of claim 14, wherein the base station causes electromagnetically sensitive equipment to be shut down upon receiving the message.

17. A method for a pico base station to serve at least one wireless communication device in an electromagnetically sensitive environment, comprising:
limiting, by the pico base station, a maximum transmission power of the pico base station to a known maximum safe value for the electromagnetically sensitive environment;
transmitting, by the pico base station, an access parameters message, to the at least one wireless communication device, wherein the access parameters message includes an initial transmission power and a power step size.

18. The method of claim 17, further comprising:
broadcasting, by the pico base station, a notification message, wherein the notification message informs the at least one wireless communication device that the at least one wireless communication device is in the electromagnetically sensitive environment.

19. A wireless communication device comprising:
a memory for storing a second value of a maximum transmission power and a first value of the maximum transmission power, wherein the second value of the maximum transmission power is nonzero and less than one percent of the first value of the maximum transmission power; and
a transmission power controller, coupled to the memory, for selecting the second value of the maximum transmission power if a selected operating mode of the wireless communication device is a “factory safe” mode.

20. The wireless communication device of claim 19, further comprising:
a mode selector, coupled to a processor, for selecting an operating mode of the wireless communication device;
a display unit, coupled to the processor, for displaying a choice of at least two operating modes supported by the wireless communication device;
a transmitter, coupled to the processor, for transmitting a signal to a pico base station; and
a receiver, coupled to the processor, for receiving a notification message broadcasted by the pico base station.

21. The wireless communication device of claim 20, further comprising:
a GPS receiver, coupled to the processor, for determining a location of the wireless communication device, wherein the mode selector automatically selects “factory safe” mode when the location is within a pre-determined list of at least one location range.
